(19) United States
(12) Patent Application Publication
(10) Pub. No.: US 2008/0260924 A1
(43) Pub. Date: Oct. 23, 2008

(54) Composition Comprising Five Kinds of Processed Fruit or Vegetables

(76) Inventors: Liang-Rong Chen, Jhunan Township (TW); Ying-Jung Wu, Jhunan Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/042,498

(22) Filed: Mar. 5, 2008

(30) Foreign Application Priority Data
Apr. 20, 2007 (TW) 096114125

(51) Int. Cl. A23L 1/30; A23L 1/275; C11B 5/00

(52) U.S. Cl. 426/540; 426/615; 426/541; 426/648

(57) ABSTRACT

The present invention discloses a nutritional composition, comprising at least five kinds of processed fruit/vegetables: green processed fruit/vegetables, yellow/orange processed fruit/vegetables, white processed fruit/vegetables, red processed fruit/vegetables, and blue/purple processed fruit/vegetables. Moreover, the composition may further comprise at least one kind of artificially-added phytochemical, which is selected from the group consisting of flavonoids, carotenoids, phenolic acids, organosulfur compounds, other phytochemicals, and mixtures thereof.

### BACKGROUND OF THE INVENTION

1. Field of the Invention

The present invention relates to a nutritional composition. More specifically, the invention relates to a nutritional composition comprising five kinds of processed fruit or vegetables of different colors and to the nutritional composition comprising phytochemicals.

2. Description of the Related Art

For the past few decades, changes in life styles have shifted people's dietary problems from nutrition deficiency to nutrition imbalance. Recent statistics shows that more than half of our citizens have insufficient fruit and vegetable intake because of imbalanced dietary habits or busy work schedules. Moreover, even if they are provided with sufficient amounts of fruit and vegetables, most of them will still fail to get the nutrients of different fruits and vegetables completely if their diet is limited to only a few types of fruit and vegetables. A study published in 2006 by the Formosa Cancer Foundation shows that more than 65 percent of the undergraduate students in Taiwan eat less than one serving of vegetables every day and that more than 73 percent eat less than one serving of fruit. For people of different ages, fruit and vegetable intake is also highly insufficient, making them more susceptible to chronic diseases.

Indeed, there are a number of products which may be helpful for supplementing nutrients lacking in an unbalanced daily fruit and vegetable intake, such as vitamin and mineral capsules or tablets. In addition, many patents have disclosed nutritional supplements of different kinds. For example, Chinese Patent Application No. 200510012621.2 discloses a fruit/vegetable coarse fiber composition and a processing method of the same, wherein soybean peel, celery, onion and orange are freeze-dried and ultra-pulverized into fine powder useful as a medicament for lowering blood pressure, blood fat and cholesterol. Moreover, some therapeutic effects may be provided by the addition of certain substances in processed fruit or vegetables. For example, in U.S. Pat. No. 5,863,582, powdered vegetables or fruit comprising a component effective to the reinforcement of blood vessels is provided, wherein the component may be rutin or chondroitin-protein complex.

Although many nutrition supplements can be bought on the market and different kinds of processed fruit and vegetables are disclosed in patent specifications, most of these products and technical solutions are single effect-oriented and fail to propose a combination of the essences from different types of fruit and vegetable.

With advances in technology in fruit and vegetable studies in the past decades, researchers have gradually reached the realization that vitamins, minerals, and fibers are not the only substances beneficial for human health. There is also a group of compounds called phytochemicals that may produce desirable physiological effects when ingested. Pigments in vegetables and fruit of different colors, these phytochemicals not only serve as color providers but also play an important role in the defense mechanisms of the vegetables and fruit. So far, several functions of phytochemicals have been well established. For example, they are very good antioxidants; they can increase the activities of detoxication enzymes in human body; they can enhance the human immunological system; and they may help regulate hormones and provide antibacterial effects.

In order to boost the nutritional values of food by the use of phytochemicals, WO99/35917 discloses a method for infusing phytochemicals into food by increasing brix of an osmotic dehydration solution containing the food product over a period of time and incubating the food product with the composition containing phytochemicals. Moreover, Taiwan Patents No. I260205 and I241893 both disclose a composition prepared by extracting phytochemicals from plant matter and its use. The composition is enriched in plant extracts including saponogenins, saponins, lignans, phenolic acids, catechins and isoflavones, and especially those extracted from a family of plants including soy, flax, tea, and cocoa.

Unfortunately, no products or technical solutions capable of providing a more comprehensive nutrition supplement, whether on the market or in patent documents, have been proposed; therefore, it is desirable to provide a nutritional composition containing a more complete set of phytochemicals found in different kinds of fruit and vegetables and other nutrients; the nutritional composition is capable of providing the essences of different fruits and vegetables and may produce different physiological functions by the addition of phytochemicals.

### SUMMARY OF THE INVENTION

It is therefore an object of the present invention to provide a nutritional composition in which all fruits and vegetables are divided into five categories based on their color, and the nutritional composition shall comprise at least one fruit or vegetable from each category. The nutritional composition may provide a balanced nutrient combination by its containing a more complete list of fruits and vegetables.

It is another object of the present invention to provide a nutritional composition comprising at least five kinds of processed fruit/vegetable: green processed fruit/vegetable, yellow/orange processed fruit/vegetable, white processed fruit/vegetable, red processed fruit/vegetable, and blue/purple processed fruit/vegetable. Because the nutritional composition comprises five kinds of processed fruit or vegetables of different colors, it may provide the nutrients of fruit or vegetables of five different colors. In addition, the fruit or vegetable matter is in the processed form, so the nutritional composition may be produced by the automated mass production methods commonly used in the food industry, providing consumers with an efficient way to get the nutrients from the five kinds of fruit or vegetables of different colors and obviating the inconvenience caused by buying the fruit or vegetables separately.

It is still another object of the present invention to provide a nutritional composition comprising five kinds of processed fruit or vegetables. Compared with five kinds of actual fruit or vegetables, the nutritional composition of this invention is more preservable and may be formulated into different forms and flavors. For areas where fruit or vegetables spoil easily or where delivery of fruit or vegetables is inconvenient, the nutritional composition of this invention may work as a desirable nutrient supplement of fruit and vegetables and balance people's daily nutrition intake. For people with chewing difficulty, such as the elderly, the nutritional composition of this invention may be in a variety of forms (such as, but not limited to, capsules or chewable tablets) to meet different needs.

It is yet another object of the present invention to provide a nutritional composition comprising five kinds of processed fruit or vegetables and at least one kind of artificially added phytochemical. The benefit of phytochemicals to the human body has already been recognized in many clinical studies; therefore, the nutritional composition of this invention may provide not only the essences of fruit or vegetables but also specific physiological effects, largely lowering the risk of cancer, heart disease, hypertension, stroke, diabetes, and other chronic diseases.

It is also an object of the present invention to provide a nutritional composition comprising at least one artificially added phytochemical and five kinds of fruit or vegetables. The phytochemical may be selected from the group consisting of flavonoid, carotenoid, phenolic acid, organosulfur compounds, other phytochemicals, and mixtures thereof. Flavonoid phytochemicals are known for their capability of providing anti-allergic, anti-inflammatory, antibacterial, and anti-cancer functions. In addition, they may serve as anti-oxidants. Carotenoid phytochemicals are also anti-oxidants and play an important role in two different aspects: first, they are sources of vitamin A; second, by their anti-oxidative property, they may prevent cancer, protect the cardiovascular system, and prevent retinal degeneration. Phenolic acid phytochemicals may be released from chemical bonds during the digestion of fruit or vegetables and exert their anti-oxidative property so as to prevent damage caused by high oxidation pressure Organosulfur phytochemicals may work against the oxidation pressure caused by sunlight radiation and protect humans from being harmed by air pollution. Other phytochemicals are those not belonging to the aforementioned four kinds of phytochemicals; these compounds, on the basis of their structures, may also provide some physiological effects, such as lowering blood sugar and cholesterol and inhibiting the growth of tumors.

To achieve the objects mentioned above, this invention provides a nutritional composition comprising five kinds of processed fruit or vegetables as follows: (a) green processed fruit or vegetables, (b) yellow or orange processed fruit or vegetables, (c) white processed fruit or vegetables, (d) red processed fruit or vegetables, and (e) blue or purple processed fruit or vegetables. In this invention, green fruit or vegetables may be fruit or vegetables containing chlorophyll and having a green appearance. For example, they can be but are not limited to asparagus, broccoli, spinach, cabbage, mustard greens, kale, bok choy, Chinese cabbage, Chinese chives, leaf lettuce, Chinese amaranth, celery, green onion, vegetable sponge, sweet potato vines, water spinach, string beans, bell peppers, kiwi fruit, avocados, guava, limes, or green tea. Yellow or orange fruit or vegetables may be any fruit or vegetables having carotenoid and a yellow or orange appearance. For example, they can be without limitation pumpkins, sweet corn, sweet potato, carrots, papaya, grapefruit, pineapple, cantaloupe, oranges, tangerines, mangos, or persimmons. Red fruit or vegetables may be any fruit or vegetables containing lycopene and red in color. For example, they can be without limitation edible gynura, tomatoes, apples, bell peppers, cranberries, strawberries, raspberries, cherries, or watermelon. Blue or purple fruit or vegetables may be any fruit or vegetables containing anthocyanin and with a blue or purple color. For example, they can be without limitation eggplant, blueberries, grapes, nori, prunes, or grapes. White fruit or vegetables refers to fruit or vegetables that are white in appearance and not belonging to the green, yellow or orange, red, and blue or purple vegetables or fruit mentioned above. For example, they can be without limitation cauliflower, yams, onions, garlic, bitter melon, radishes, bamboo shoots, great burdock, bananas, or pears.

To further increase the nutritional value of the composition of this invention, it may further comprise at least one kind of artificially added phytochemical. Preferably, the phytochemical is selected from the group consisting of flavonoid, carotenoid, phenolic acid, organosulfur compound, other phytochemicals, and mixtures thereof. The flavonoid phytochemical may be without limitation anthocyanin, apigenin, catechin, hesperetin, isoflavone, kaempferol, luteolin, myricetin, naringenin, proanthocyanidin, quercetin, resveratrol, or rutin. The carotenoid phytochemical may be without limitation beta-carotene, beta-cryptoxanthin, lutein, lycopene, or zeaxanthin. The phenolic acid phytochemical may be without limitation chlorogenic acid, ellagic acid, ferulic acid, gallic acid, or p-coumaric acid. The organosulfur phytochemical may be without limitation ajoene, allicin, allyl propyl disulphide (APDS), glutathione, indole, isothiocyanate, or sulforaphane. The other type of phytochemical may be without limitation beta-sitosterol, charantin, D-glucaric acid, diosgenin, D-limonene, gamma-L-glutamyl-trans-1-propenyl-L-cysteine sulfoxide (GPCS), limonoids, pthalides, saponin, or v-insulin. More preferably, the phytochemical is selected from the group consisting of lycopene, sulforaphane, proanthocyanidin, allicin, citrus bioflavonoid, charantin, zeaxanthin, lutein, anthocyanin, chlorogenic acid, diosgenin, and mixtures thereof.

In this invention, the processed fruit or vegetable product is one made by industrial processing. For example, it may be without limitation fruit or vegetable juice, fermented broth, dried fruit or vegetables, canned or pickled fruit or vegetables, brewed vinegar or wine, a powder, or a conserve. In addition, the nutritional composition of this invention may also be made into different oral formulations; for example, it may be without limitation tablets, capsules, powder softgels, gelcaps, liquids, chewable tablets, effervescent tablets, or jelly.

Furthermore, this invention also provides a nutritional composition comprising five kinds of processed fruit and five kinds of processed vegetables as follows: (a) green processed vegetables, (b) yellow or orange processed vegetables, (c) white processed vegetables, (d) red processed vegetables, (e) blue or purple processed vegetables, (f) green processed fruit, (g) yellow or orange processed fruit, (h) white processed fruit, (i) red processed fruit, and (j) blue or purple processed fruit. Since the nutritional composition comprises processed fruit and vegetables of different colors, it may provide more complete nutritional essences than general vitamins or food supplements. In some situations, the nutritional composition may further comprise different phytochemicals, such as lycopene, sulforaphane, proanthocyanidin, allicin, citrus bioflavonoid, ellagic acid, charantin, lutein, or zeaxanthin.

All these ingredients may be combined with necessary binders, excipients, preservatives, colors and the like known to those in the industry in order to produce a suitable nutritional composition.

### DETAILED DESCRIPTION OF THE PREFERRED EMBODIMENT

Other objects, advantages, and novel features of the invention will become more apparent from the following detailed description when taken in conjunction with the accompanying embodiments

Preparation of the Processed Fruit or Vegetables

In order to provide a processed nutritional composition, the vegetable or fruit contained therein is processed by food processing means. The usable processing means may be without limitation squeezing, fermentation, drying, canning, pickling, brewing, or sugaring. Drying may be done without limitation by low-temperature dehydrated drying, hot-air drying, spray drying, vacuum drying, or freeze drying; pickling may be done without limitation by salt, sugar, or condiment.

The processed fruit or vegetables made thereby, depending on the process used, may be without limitation in the form of juice, fermented broth, dried fruit or vegetables, canned or pickled fruit or vegetables, brewed vinegar or wine, a powder, or a conserve. In addition, the nutritional composition of this invention may be without limitation in the form of tablets, capsules, powder softgels, gelcaps, liquids, chewable tablets, effervescent tablets, or jelly.

The powder form can be used as a representative example. During the processing, fruit and vegetables may be treated by the same way or differently; for example, the vegetable powder may be made by grinding a dried product previously dehydrated at 60 to 65□; the fruit powder may be made by concentrating fruit juice to five to nine times its original concentration, followed by the addition of malt dextrin and spray drying.

It should be noted that the process mentioned above is only one of the many embodiments of this invention; the nutritional composition may also be made by other well-known processes. For example, the drying temperature is not limited to 60 to 65□, and the additive used in spray drying is not limited to malt dextrin.

Preparation of Phytochemicals

In this invention, at least one phytochemical may be selectively added to boost the nutritional value of the nutritional composition. The phytochemical may be extracted from natural products or made by artificial synthesis. In the example of extraction and fractionation of natural products, the fruit or vegetables are washed and sterilized; organic solvent is used in extraction; and the extracted substances are dried for a period of time so as to obtain the phytochemical powder. Since the preparation of phytochemicals is well known in the art, further elaboration is omitted. Some common methods used in extraction and fractionation can be found in U.S. Pat. Nos. 5,702,752, 6,033,714, and 4,428,876.

Nutritional Composition

### EXAMPLE 1

### Five-Color Vegetable/Fruit (Capsule, 750 mg Each)

| Color | Ingredient | Percentage by weight |
|---|---|---|
| Red | tomato powder | 1%~90% |
| Green | broccoli powder | 1%~50% |
| White | garlic powder | 1%~50% |
| Yellow/orange | citrus powder | 1%~50% |
| Blue/purple | grape powder | 1%~50% |

In this example, the ingredient of the composition may be easily changed by the alternation or combination of the sources of the processed vegetable or fruit. In addition, research has shown that different kinds of processed vegetable or fruit are more beneficial to certain health conditions; therefore, the ratio of the ingredients is not specifically limited.

### EXAMPLE 2

### Five-Color Vegetable/Fruit+Lycopene (Capsule, 750 mg Each)

| Color | Ingredient | Percentage by weight |
|---|---|---|
| Red | tomato powder | 1%~90% |
| Green | broccoli powder | 1%~50% |
| White | garlic powder | 1%~50% |
| Yellow/orange | citrus powder | 1%~50% |
| Blue/purple | grape powder | 1%~50% |
| | Lycopene | 0.1%~2% |

In this embodiment, an effective amount of lycopene is added to the capsule. It has been shown that lycopene may provide a preventive effect against various cancers, such as ovarian cancer, lung cancer, pancreatic cancer, oral cancer, esophagus cancer, gastric cancer, colon cancer, breast cancer, and prostate cancer In addition, lycopene may inhibit the synthesis of cholesterol and its anti-oxidative activity may prevent low density lipoprotein-cholesterol from being oxidated and obstructing the blood vessel wall. Also, lycopene is anti-inflammatory, and epidemiological research has shown that people with more lycopene in their diet are less susceptible to prostate cancer. Therefore, the nutritional composition of this example may help reduce cholesterol, protect prostate glands, and provide anti-oxidative functions.

### EXAMPLE 3

### Five-Color Vegetable/Fruit+Sulforaphane (Capsule, 750 mg Each)

| Color | Ingredient | Percentage by weight |
|---|---|---|
| Red | edible gynura powder | 1%~50% |
| Green | broccoli powder | 1%~90% |
| White | yam powder | 1%~50% |
| Yellow/orange | pumpkin powder | 1%~50% |
| Blue/purple | eggplant powder | 1%~50% |
| | Sulforaphane | 0.01%~4% |

In this embodiment, the percentage of green vegetable or fruit is higher, and an effective amount of sulforaphane is added to the capsule. Sulforaphane, which is a strong anti-oxidant, may bind to free radicals to protect DNA from damage. In addition, it may induce the production of the detoxication enzyme in the liver and increase the carcinogen preventive capability of the body. In animal experiments, it has been shown that sulforaphane intake in animals suffering from breast cancer or prostate cancer is helpful in the control of tumor size and number. In addition, research has shown that animals ingesting more sulforaphane in their diet are less susceptible to colon cancer. Sulforaphane may also increase people's resistance against helicobacter pylori. Therefore, the nutritional composition of this embodiment may increase the body's detoxication anti-cancer capabilities.

### EXAMPLE 4

### Five-Color Vegetable/Fruit+Proanthocyanidin (Capsule, 750 mg Each)

| Color | Ingredient | Percentage by weight |
|---|---|---|
| Red | apple powder | 1%~50% |
| Green | spinach powder | 1%~50% |
| White | cauliflower powder | 1%~50% |
| Yellow/orange | sweet corn powder | 1%~50% |
| Blue/purple | grape powder | 1%~90% |
| | proanthocyanidin | 0.1%~20% |

In this embodiment, the percentage of blue/purple vegetable or fruit is higher, and an effective amount of proanthocyanidin is added to the capsule. In vitro experiments show that proanthocyanidin possesses stronger anti-oxidative power than vitamin C or vitamin E. Different studies also demonstrate that proanthocyanidin may prevent diseases caused by excessive free radicals, such as atherosclerosis, arthritis, gastrointestinal tumor, and cataract. In addition, proanthocyanidin may also ameliorate chronic venous insufficiency and prevent ulcer in the urethra due to the accumulation of bacteria. Therefore, the nutritional composition of this example may provide an anti-oxidative function and prevent inflammation of the urethra.

### EXAMPLE 5

### Five-Dolor Vegetable/Fruit+Allicin (Capsule, 750 mg Each)

| Color | Ingredient | Percentage by weight |
|---|---|---|
| Red | bell pepper powder | 1%~50% |
| Green | cabbage powder | 1%~50% |
| White | garlic powder | 1%~90% |
| Yellow/orange | sweet potato powder | 1%~50% |
| Blue/purple | nori powder | 1%~50% |
| | Allicin | 0.1%~3% |

In this embodiment, the percentage of white vegetable or fruit is higher, and an effective amount of allicin is added to the capsule. Epidemiologic studies have shown that people in countries where garlic consumption is high are less susceptible to gastric ulcer because allicin may inhibit the growth of helicobacter pylori. Allicin may also prevent low density lipoprotein-cholesterol from being oxidated and causing vascular sclerosis. In addition, allicin can inhibit the agglutination of platelets and prevent obstruction of the blood vessel wall. Therefore, the nutritional composition of this example may prevent vascular sclerosis and gastric ulcer.

### EXAMPLE 6

### Five-Color Vegetable/Fruit+Citrus Bioflavonoid (Capsule, 750 mg Each)

| Color | Ingredient | Percentage by weight |
|---|---|---|
| Red | cranberry powder | 1%~50% |
| Green | mustard green powder | 1%~50% |
| White | bitter melon powder | 1%~50% |
| Yellow/orange | citrus powder | 1%~90% |
| Blue/purple | prune powder | 1%~50% |
| | citrus bioflavonoid | 1%~90% |

In this embodiment, the percentage of yellow/orange vegetable or fruit is higher, and an effective amount of citrus bioflavonoid is added to the capsule. Citrus bioflavonoid may increase the absorption of vitamin C. Studies also show that eating citrus fruit frequently may decrease the risk of oral cancer, cancer of the larynx, and gastric cancer to 50%. In addition, citrus bioflavonoid may prevent cancer and provide an anti-oxidative function as well as strengthen the immune system. Therefore, the nutritional composition of this embodiment may provide anti-oxidative and cardiovascular protection effects.

### EXAMPLE 7

### Five-Color Vegetable/Fruit+Ellagic Acid (Capsule, 750 mg Each)

| Color | Ingredient | Percentage by weight |
|---|---|---|
| Red | strawberry powder | 1%~50% |
| Green | kale powder | 1%~50% |
| White | radish powder | 1%~50% |
| Yellow/orange | papaya powder | 1%~50% |
| Blue/purple | prune powder | 1%~50% |
| | ellagic acid | 1%~10% |

In this embodiment, an effective amount of ellagic acid is added to the capsule. Ellagic acid may induce the detoxication enzyme in the liver to convert carcinogens into excretable substances and thus decrease susceptibility to cancer. In addition, ellagic acid may accelerate the death of cancer cells, prevent gastric ulcer, and alleviate the uncomfortable feelings caused by chemotherapy. Therefore, the nutritional composition of this embodiment may provide an anti-cancer effect.

### EXAMPLE 8

### Five-Color Vegetable/Fruit+Charantin (Powder, 8 g Each Pack)

| Color | Ingredient | Percentage by weight |
|---|---|---|
| Red | raspberry powder | 1%~50% |
| Green | bok choy powder | 1%~50% |
| White | bitter melon powder | 1%~90% |
| Yellow/orange | grape fruit powder | 1%~50% |
| Blue/purple | raisin powder | 1%~50% |
| | Charantin | 0.001%~0.03% |

In this embodiment, the percentage of white vegetable or fruit is higher, and an effective amount of charantin is added to the capsule. It has been shown that charantin may stimulate the beta cells of the pancreas to secrete insulin and lower blood sugar. Therefore, the nutritional composition of this embodiment may lower blood sugar and prevent several metabolic syndromes.

### EXAMPLE 9

### Five-Color Vegetable/Fruit+Chlorogenic Acid (Capsule, 750 mg Each)

| Color | Ingredient | Percentage by weight |
|---|---|---|
| Red | apple powder | 1%~50% |
| Green | avocado powder | 1%~50% |
| White | great burdock powder | 1%~50% |
| Yellow/orange | carrot powder | 1%~50% |
| Blue/purple | blueberry powder | 1%~50% |
| | chlorogenic acid | 0.5%~30% |

In this embodiment, an effective amount of chlorogenic acid is added to the capsule. It has been shown that chlorogenic acid may help regulate the concentration of blood sugar and lower the rate of the conversion of glycogen into blood sugar as well as the absorption of sugar in the gastrointestinal track; thus, chlorogenic acid may prevent the sharp increase of blood sugar after a meal. A study has shown that women who drink three cups of coffee a day rarely develop biliary calculus because the chlorogenic acid in coffee may effectively facilitate the flow of bile. In addition, like most poly-phenols, chlorogenic acid is also an anti-oxidant and may capture free radicals and prevent them from causing damage. Also, chlorogenic acid may induce the detoxication enzyme in the liver to convert carcinogens into excretable substances and decrease susceptibility to cancer. Therefore, the nutritional composition of this example may be used to control blood sugar and to prevent biliary calculus and cancer.

### EXAMPLE 10

### Five-Color Vegetable/Fruit+Lutein+Zeaxanthin (Tablet, 1000 mg Each)

| Color | Ingredient | Percentage by weight |
|---|---|---|
| Red | tomato powder | 0.5%~50% |
| Green | bok choy powder | 0.5%~50% |
| White | bitter melon powder | 0.5%~50% |
| Yellow/orange | grapefruit powder | 0.5%~50% |
| Blue/purple | raisins powder | 0.5%~50% |
| | lutein | 0.05%~5% |
| | zeaxanthin | 0.005%~0.5% |

In this embodiment, effective amounts of lutein and zeaxanthin are added to the capsule. Lutein may provide a desirable anti-oxidative effect and prevent free radicals from damaging the yellow spot area and lens and thus resulting injury; in addition, lutein may also protect the cardiovascular system. Zeaxanthin may be used to further increase lutein's capability of protecting the visual system. Therefore, the nutritional composition of this embodiment may protect the visual system by preventing retinal degenerative diseases and cataract.

### EXAMPLE 11

### Five-Color Vegetable/Fruit (Capsule, 750 mg Each)

| Color | Ingredient | Percentage by weight |
|---|---|---|
| Red | tomato powder | 1%~90% |
| | bell pepper powder | 1%~90% |
| | cranberry powder | 1%~90% |
| | strawberry powder | 1%~90% |
| Green | broccoli powder | 1%~90% |
| | spinach powder | 1%~90% |
| | celery powder | 1%~90% |
| | kiwi fruit powder | 1%~90% |
| White | Bitter melon powder | 1%~90% |
| | banana powder | 1%~90% |
| | garlic powder | 1%~90% |
| | onion powder | 1%~90% |
| Yellow/orange | grapefruit powder | 1%~90% |
| | mango powder | 1%~90% |
| | citrus powder | 1%~90% |
| | carrot powder | 1%~90% |
| | pumpkin powder | 1%~90% |
| Blue/purple | eggplant powder | 1%~90% |
| | blueberry powder | 1%~90% |
| | nori powder | 1%~90% |

In this embodiment, more than five kinds of vegetables and more than five kinds of fruit are integrated into the nutritional composition. The comprehensive inclusion of fruit and vegetables enables the composition to include the essences of different fruits and vegetables; in addition, the combination of the ingredients meets the five-color concept, providing consumers with a more complete nutrition supplement than common vitamin tablets. Therefore, the nutritional composition of this embodiment may provide balanced and comprehensive nutrition essences of fruit and vegetables.

### EXAMPLE 12

### Five-Color Vegetable/Fruit (Brewed Vinegar, 500 ml Each Bottle)

a. Brown rice is brewed by the following steps:

a1. Cleansing and steaming—brown rice is steamed after soaking in water for an hour.

a2. Cooling—the steamed brown rice is spread to dissipate the heat.

a3. Liquefaction and saccharification—the steamed brown rice is inoculated with Aspergillus oryzae so as to carry out saccharification.

a4. Alcoholization—a volume of water three times that of the liquefied and saccharified product is added and inoculated with yeast to carry out alcoholization.

a5. Vinegarization—acetic acid bacteria are added to carry out aerobic metabolism for three to four months to obtain brown rice vinegar.

b. The preparation of the five-color vegetable/fruit pieces is as follows:

| Color | Name | Process |
|---|---|---|
| Red | apple | washing and cutting into pieces without |
| | | peeling |
| Green | kiwi fruit | washing, peeling, and cutting into pieces |
| White | bitter melon | washing, pitting, and cutting into pieces |
| Yellow/orange | pumpkin | washing and cutting into pieces without |
| | | peeling |
| Blue/purple | grape | Washing |

c. Mixing the brown rice vinegar and the vegetable/fruit pieces: the brown rice vinegar obtained from step (a) and the vegetable/fruit pieces obtained from step (b) are mixed in a ratio of 2:1 by weight and soaked for at least two months. The brewed vinegar of five-color vegetable/fruit may be obtained, and this vinegar may help regulate the metabolism and immune system and protect the gastrointestinal track.

### EXAMPLE 13

### Five-Color Vegetable/Fruit (Fermented Broth, 500 ml Each Bottle)

a. The preparation of the five-Color Vegetable/Fruit pieces is as follows:

| Color | Name | Process |
|---|---|---|
| Red | Apple | washing, cutting into pieces without peeling, |
| | | and draining the water away |
| Green | Guava | washing, peeling, cutting into pieces, and |
| | | draining the water away |
| White | Yam | washing, peeling, cutting into pieces, and |
| | | draining the water away |
| Yellow/orange | pumpkin | washing, cutting into pieces without peeling, |
| | | and draining the water away |
| Blue/purple | grape | washing and draining the water away |

b. Conducting the fermentation by the following steps:

b1. Prepare the five-color vegetable/fruit pieces in a container.

b2. Add into the container granulated sugar of a weight equal to the weight of the vegetable/fruit pieces.

b3. Add into the container five-color vegetable/fruit pieces again.

b4. Add into the container granulated sugar of a weight equal to the weight of the vegetable/fruit pieces in b3.

b5. Add yeast to the container.

b6. Add into the container five-color vegetable/fruit pieces again.

b7. Add into the container granulated sugar of a weight equal to the weight of the vegetable/fruit pieces in b6.

b8. Conduct gravitational squeezing.

b9. Cover the container with gauze and carry out fermentation for at least one month.

b10. Filter the fermented product to obtain the fermented broth of the five-color vegetable/fruit.

As with the brewed vinegar of the five-color vegetable/fruit in example 13, the fermented broth of the five-color vegetable/fruit may also help regulate the metabolism and immune system and protect the gastrointestinal track.

Anti-Oxidative Effects of the Five-Color Vegetable/Fruit Capsule

To illustrate the anti-oxidative effects of the five-color vegetable/fruit capsule, the following data is provided as a reference.

In an experiment, nine subjects were chosen, and their urine was collected for analysis before they took the capsule of this invention. To measure the subjects' oxidative pressure, 8-hydroxy-2′-deoxyguanosine (8-OHdG) was chosen as the indicator because it is the oxidation product of deoxyguanosine (dG) and because a higher 8-OHdG concentration represents higher oxidative pressure.

After having their 8-OHdG data collected, the subjects began taking the five-color vegetable/fruit capsule of this invention. The five-color vegetable/fruit capsule includes a five-color vegetable capsule and a five-color fruit capsule, whose ingredients are as follows:

The weight of the five-color vegetable capsule is 750 mg. It contains 1% to 90% by weight bell pepper, carrot, pumpkin, broccoli, spinach, celery, black sesame, onion, garlic, yam, and bitter melon. In addition, it contains 450 μg sulforaphane and 5.63 mg allicin.

The weight of the five-color fruit capsule is 750 mg. It contains 1% to 65% by weight cranberry, strawberry, tomato, grape, grapefruit, mango, orange, kiwi fruit, blueberry, and apple. In addition, it contains 100 mg proanthocyanidin, 3.75 mg lycopene, and 113 mg citrus bioflavonoid.

Subjects took one five-color fruit capsule and one five-color vegetable capsule every morning and every night for two months, and their urine was collected again at the end of the experiment for analysis of the 8-OHdG concentration. The results are as follows:

| | Subject No. | | | | | | | | |
|---|---|---|---|---|---|---|---|---|---|
| | 1 | 2 | 3 | 4 | 5 | 6 | 7 | 8 | 9 |
| Pre- | 44.0 | 54.8 | 41.9 | 54.1 | 49.4 | 36.1 | 49.4 | 39.1 | 20.2 |
| experi- | | | | | | | | | |
| ment | | | | | | | | | |
| (ng/mg) | | | | | | | | | |
| Post- | 41.5 | 29.1 | 19.8 | 46.0 | 39.6 | 27.7 | 50.1 | 28.3 | 18.9 |
| experi- | | | | | | | | | |
| ment | | | | | | | | | |
| (ng/mg) | | | | | | | | | |

It can been seen from the table above that the subjects' average 8-OHdG concentration was lowered from 43.2 ng/mg to 33.4 ng/mg (p=0.011), indicating that the nutritional composition of this invention possesses a strong anti-oxidative effect. Since oxidative pressure has a high correlation to the occurrence of various diseases and cancers, it can be said that the nutritional composition of this invention may largely decrease the occurrence of those diseases and cancers.

Thus, while only several embodiments of the present invention have been illustrated and described, it will be appreciated by those skilled in the art that many changes and modifications may be made thereunto without departing from the spirit and scope of the invention.

What is claimed is:

1. A nutritional composition, comprising five kinds of processed fruit or vegetables as follows:
(a) green processed fruit or vegetables, (b) yellow or orange processed fruit or vegetables, (c) white processed fruit or vegetables, (d) red processed fruit or vegetables, and (e) blue or purple processed fruit or vegetables.

2. The nutritional composition of claim 1, further comprising at least one kind of artificially-added phytochemical.

3. The nutritional composition of claim 2, wherein the artificially-added phytochemical is selected from the group consisting of flavonoid, carotenoid, phenolic acid, organosulfur compound, other phytochemicals, and mixtures thereof.

4. The nutritional composition of claim 1, further comprising at least one kind of artificially-added phytochemical selected from the group consisting of lycopene, sulforaphane, proanthocyanidin, allicin, citrus bioflavonoid, charantin, zeaxanthin, lutein, anthocyanin, chlorogenic acid, diosgenin, and mixtures thereof.

5. The nutritional composition of claim 1, which is a capsule.

6. The nutritional composition of claim 1, which is a powder.

7. The nutritional composition of claim 1, which is a chewable tablet.

8. The nutritional composition of claim 1, which is a brewed vinegar.

9. The nutritional composition of claim 1, which is a fermented broth.

10. The nutritional composition of claim 1, which comprises five kinds of processed fruit and five kinds of processed vegetables as follows:
(a) green processed vegetables, (b) yellow or orange processed vegetables, (c) white processed vegetables, (d) red processed vegetables, (e) blue or purple processed vegetables, (f) green processed fruit, (g) yellow or orange processed fruit, (h) white processed fruit, (i) red processed fruit, and (j) blue or purple processed fruit.

11. A nutritional composition, comprising at least one kind of artificially-added phytochemical and five kinds of processed fruit or vegetables as follows:
(a) green processed fruit or vegetables, (b) yellow or orange processed fruit or vegetables, (c) white processed fruit or vegetables, (d) red processed fruit or vegetables, and (e) blue or purple processed fruit or vegetables,
wherein the artificially-added phytochemical is selected from the group consisting of flavonoid, carotenoid, phenolic acid, organosulfur compound, other phytochemicals, and mixtures thereof.
